(19) United States
(12) Patent Application Publication
(10) Pub. No.: US 2017/0317562 A1
(43) Pub. Date: Nov. 2, 2017

(54) ROTATING ELECTRIC MACHINE INTEGRATED WITH CONTROLLER

(71) Applicant: DENSO CORPORATION, Kariya-city (JP)

(72) Inventors: Nobuhiro ASANO, Kariya-city (JP); Yuki MAWATARI, Kariya-city (JP); Koji KONDO, Kariya-city (JP); Hiroshi INAMURA, Kariya-city (JP); Masataka YOSHIMURA, Kariya-city (JP); Yuki SUZUKI, Kariya-city (JP)

(73) Assignee: DENSO CORPORATION, Kariya-city (JP)

(21) Appl. No.: 15/497,593

(22) Filed: Apr. 26, 2017

(30) Foreign Application Priority Data
Apr. 29, 2016 (JP) 2016-092169
Feb. 21, 2017 (JP) 2017-029993

(51) Int. Cl. H02K 11/33; H02K 11/25; H02K 5/22; H02K 9/02

(52) U.S. Cl. CPC H02K 11/33; H02K 9/02; H02K 11/25; H02K 5/225

(57) ABSTRACT

A rotating electric machine integrated with a controller includes a rotating electric machine provided with a stator having three phase stator windings, a power converter configuring the control circuit of the rotating electric machine, a control board equipped with electronic components, and a plurality of modules provided with a plurality of switching elements controlled by the control circuit. At least one of the modules is provided with the switching elements controlling the two different sets of stator windings, and a detection element detecting a state of the module.

### CROSS-REFERENCE TO RELATED APPLICATION

This application is based on and claims the benefit of priority from earlier Japanese Patent Application No. 2016-92169, filed on Apr. 29, 2016, and Japanese Patent Application No. 2017-29993 filed on Feb. 21, 2017, the description of which is incorporated herein by reference.

### BACKGROUND OF THE INVENTION

### Technical Field

The present disclosure relates to a rotating electric machine integrated with a controller.

### Related Art

Conventionally, there are rotating electric machines integrated with control devices, each provided with a rotating electric machine and a control device.

The rotating electric machine integrated with a controller is provided with a rotating electric machine and a control device (also referred to as an inverter assembly). The control device includes a power module, a heat sink, a connection terminal, a bus bar and an insulator. The power module is adhered to the heat sink by an adhesive agent which has thermal conductivity and electrical insulating properties. The connection terminal and bus bar provided with an inner wall section, an outer wall section, and a flat wall section, are inserted in an insulator forming a case member. The insulator is adhered to the sink heater by the adhesive agent. The power module is accommodated in a concave section formed by the insulator and the heat sink. A terminal of the power module is connected to the connection terminal and the bus bar. The concave section formed by the insulator and the heat sink is filled with a filler having electrical insulating properties. An example of a hitherto rotating electric machine integrated with a controller is disclosed in JP2014-45629A and JP2011-243909A.

A rotating electric machine integrated with a controller, in JP2014-45629A, includes each one of two different power modules equipped with a same, switching element, for example, inside circuit, and an outer appearance that is substantially symmetrical. The two power modules as a pair are combined with a heat sink. In this configuration, since the two different power modules are combined with the heat sink thereon, a front end of at least one terminal of the two different power modules, exposed from the resin member to an outside thereof, is serially arranged to be projected at an equal distance to each other, that is from an surface end of both power modules. As a result, it is disclosed that miniaturization of the rotating electric machine is achieved, cooling properties and reliability can also be improved.

JP2011-243909A discloses that, in a case of using a control apparatus of a semi-conductor device (power module) as a switching element of an upper and lower arm of an inverter of a rotating electric machine for a vehicle, a switching element is needed for each phase of the upper and lower arm accordingly. As a consequence, a number of wires and a number of signal terminals connected to a temperature detection element increase, and a number of signal terminals of a control device (control by IC) also increase. In relation to above mentioned problems, it is also disclosed that, by using a power module configured with an upper and lower arm switching element, and by connecting either the upper or the lower arm of a temperature detection terminal to the signal terminal, the number of control IC ports can be reduced and miniaturization of the control device achieved

However, an integrated control device, disclosed in JP2014-45629A, employs a module which controls the upper and the lower arm using 2 switching elements, for the module of a rotating electric machine configured of two sets of three phase stator coils which is disclosed in JP2011-243909A. That is, JP2014-45629A, discloses a rotating electric machine which employs a total of 6 modules.

In the integrated control device described above, it is necessary to monitor the temperature of the 6 power modules, in order to detect abnormalities in all phases of the stator coils. As a consequence, an increase in a number of ports of the control device (control IC), which temperature monitoring results (measured results) are transmitted to, may be problematic. Specifically, the increase in the number of ports results in a bulkier control apparatus (control IC), which in turn leads to a bulkier integrated control device as a result. In view of the foregoing, the present disclosure strives to provide a rotating electric machine integrated with a controller which can detect an abnormality of an operation that is of concern, for example, detection of an abnormal temperature of a stator coil, and achieve miniaturization thereof.

### SUMMARY

In order to resolve the foregoing problems, the rotating electric machine integrated with a controller according to a first aspect of the disclosure, is provided with a rotating electric machine which has a stator and a rotor and a power converter provided with a control board and a plurality of power modules. The stator has two sets of three phase stator coils, and the control board is equipped with electronical components configuring a control circuit of the rotating electric machine. The plurality of power modules are provided with a plurality of switching elements and at least one of the modules is provided with switching elements which controls two different sets of stator coils and a detection element which detects a state of the module.

In the configuration, at least one of the modules controls two different sets of stator coils. An abnormality in the two sets of stator coils (for example, an abnormally increased temperature) can be detected, by detecting the state (for example, a temperature) of at least one of the modules using the detection element. That is, the abnormality of two sets of stator coils can be detected by detecting the state of the at least one module thus a number of detection elements required for an entire rotating electric machine can be decreased. Furthermore, a number of ports of the control apparatus (IC control) which receive a detection result transmitted from the detector element can also be decreased, which in turn decreases a size of the rotating electric machine.

The rotating electric machine integrated with a controller in a second aspect of the disclosure is provided with the power converter having a first module which controls the two different sets of the stator coils and second modules which controls the same set of the stator coils. According to the configuration, if an abnormality occurs in either one of the two sets of stator coils, the stator coil in which the abnormality has occurred can be detected from detected results of the first module and second module.

The rotating electric machine integrated with a controller in a third aspect of the disclosure, is provided with the first module having a temperature detection element as the detection element, which detects a temperature of the first module. In the configuration the state of the first module can be detected using the temperature.

The rotating electric machine integrated with a controller, in a fourth aspect of the disclosure, is provided with the second modules having the temperature detection elements as the detection elements, which detect a temperature of the second modules. In the configuration a state of the second modules can be detected.

The rotating electric machine integrated with a controller in a fifth aspect of the disclosure, has each of the modules provided with a heat sink thermally insulated from a different module among the modules. In the configuration, a transmission of heat to each module through the heat sink disposed between adjacent modules is suppressed. As a result, a decrease in the precision of detected results of transmitted heat detected is also suppressed.

The rotating electric machine integrated with a control device, in a sixth aspect of the disclosure, is provided with the control board having an open circular shape. Each of the modules are disposed around a circumferential direction (CIRC) of the open circular shape and the at least one of the modules is disposed diametrically opposite to a section being an open section of the circle. In the configuration, the at least one of the modules is not in a close vicinity of the open section of the circular shape. As a result, heat dissipation from the at least one of the modules is suppressible, even if heat dissipation occurs at the open section. As a result, a decrease in the detection precision of the detection element is suppressed. It is noted that, a position diametrically opposite the open section of the open circle is the position which is diametrically opposite in a circumferential direction thereof, with reference to a center point of the circular shape of the control board.

Additionally, in the configuration described, modules other than the at least one module are disposed between the at least one module and the open section of the open circular shape. In this case, modules other than the at least one module can dissipate heat at the open section of the open circular shape. As a result, an effect of heat transmitting from other adjacent modules to the at least one modules is suppressed.

The rotating electric machine integrated with a controller in a seventh aspect of the disclosure, is provided with the control board having the open circular shape which has an open section, each of the modules disposed is around a circumferential direction (CIRC) of the open circular shape, and the first module is disposed diametrically opposite to the open section of the circular shape.

In this configuration, since the first module is disposed diametrically opposite to the open section of the open circular shape, heat dissipation of the first module from the open section of the circular shape is suppressed. Specifically, the distance between the first module detecting a state (abnormalities) of the stator coil, and the open section of the circular shape is long, thus heat dissipates with difficulty from the open section of the circular shape, when the first module generates heat. The distance herein refers to a distance through which heat is transmitted through the control board.

Additionally, since the second module is disposed between the open section of the circular shape and the first module, transmission of the heat is blocked by the second modules disposed therebetween, even if the heat is transmitted towards the open section of the circular shape, when the first module dissipates heat. As a result, a decrease in the detection precision which detect a state (abnormalities) of the first module is suppressed.

The rotating electric machine integrated with a controller in an eight aspect of the disclosure, is provided with the control board having the open section of the circle formation, and connection members connecting the switching elements which control the stator coils, to an outside connection member provided on the open section of the circular shape. In the configuration, connection members may also be used for heat dissipation at the open section of the circular shape. The connection members have good heat dissipating properties. When a module generates heat, the heat transmission occurs through the connection member of the module. As a result, a heat dissipation capacity at the open section of the circular shape can be increased and the effect of heat from the adjacent modules to the normally operating module is thus suppressed. Additionally, suppression of a decrease of the detection precision of the detection element is also achieved.

The rotating electric machine integrated with a controller in a ninth aspect of the disclosure, is provided with the power converter having the connection member and heat sink connected to the external connection member integrated into resin case. The control board and module are encapsulated in the resin case by potting resin. In this configuration, potting resin decreases an effect of the peripheral temperature to the temperature detection element of the module. Additionally, if a foreign body exists in the power converter (control apparatus), the filler member suppresses contact or collision of the foreign body with other components therein. As a result, a decrease in the detection precision of the detection element is also suppressed.

### BRIEF DESCRIPTION OF THE DRAWINGS

FIG. 1 is a plan view showing a control apparatus integrated rotating electric machine according to a preferred embodiment;

FIG. 2 is cross section taken across a line II-II shown in FIG. 1;

FIG. 3 is a plan view showing a case member viewed from a side opposing a side in which the rotating electric machine is contained according to the preferred embodiment;

FIG. 4 is a cross section diagram taken across a line IV-IV shown in FIG. 3;

FIG. 5 is a plan view showing the case member viewed from the side in which the rotating electric machine is mounted;

FIG. 6 is a plan view showing a fixing member viewed from the side opposing the side containing the rotating electric machine;

FIG. 7 is a side view showing the fixing member;

FIG. 8 is a plan view showing the fixing member viewed from the side in which the rotating electric machine is mounted;

FIG. 9 is a plan view showing the fixing member viewed from the side opposing the side containing the rotating electric machine;

FIG. 10 is a diagram showing a side view of second fixing member;

FIG. 11 is a plan view showing the second fixing member viewed from a side in which the rotating electric machine is mounted;

FIG. 12 is a plan view showing a heat sink for a power module viewed from the side opposing side containing the rotating electric machine;

FIG. 13 is a diagram of a side view of the heat sink for the power module;

FIG. 14 is a plan view showing the heat sink for the power module viewed from the side in which the rotating electric machine is mounted;

FIG. 15 is a plan view showing the case member with the power module disposed (thereon) viewed from the side opposing the side containing the rotating electric machine;

FIG. 16 is a cross sectional diagram taken across a line XVI-XVI shown in FIG. 15;

FIG. 17 is a cross sectional diagram showing the case member with a wire board disposed thereon, viewed from the side opposing the side containing the rotating electric machine;

FIG. 18 is a cross sectional diagram between arrow XVIII-XVIII in FIG. 17;

FIG. 19 is a cross sectional diagram showing a magnetic circuit mounted on a wiring board and a periphery of the heat sink for the magnetic circuit IC;

FIG. 20 is a cross sectional diagram showing a micro-computer mounted on the wiring board and the periphery of the heat sink for the micro-computer;

FIG. 21 is a cross sectional diagram showing a control apparatus of a charging member in a charged state;

FIG. 22 is a diagram showing a circuit of a rotating electric machine integrated with a controller of a preferred embodiment;

FIG. 23 is a diagram showing a circuit of a rotating electric machine integrated with a controller, according to a modified mode 1; and

FIG. 24 is a diagram showing a circuit of a rotating electric machine integrated with a controller of according to a modified mode 2.

### DETAILED DESCRIPTION OF THE PREFERRED EMBODIMENT

A preferred embodiment of the present disclosure is described with reference to the accompanying drawings. A rotating electric machine integrated with a controller in the preferred embodiment is shown as an example of a rotating electric machine integrated with a controller, mounted in a vehicle.

### Preferred Embodiments

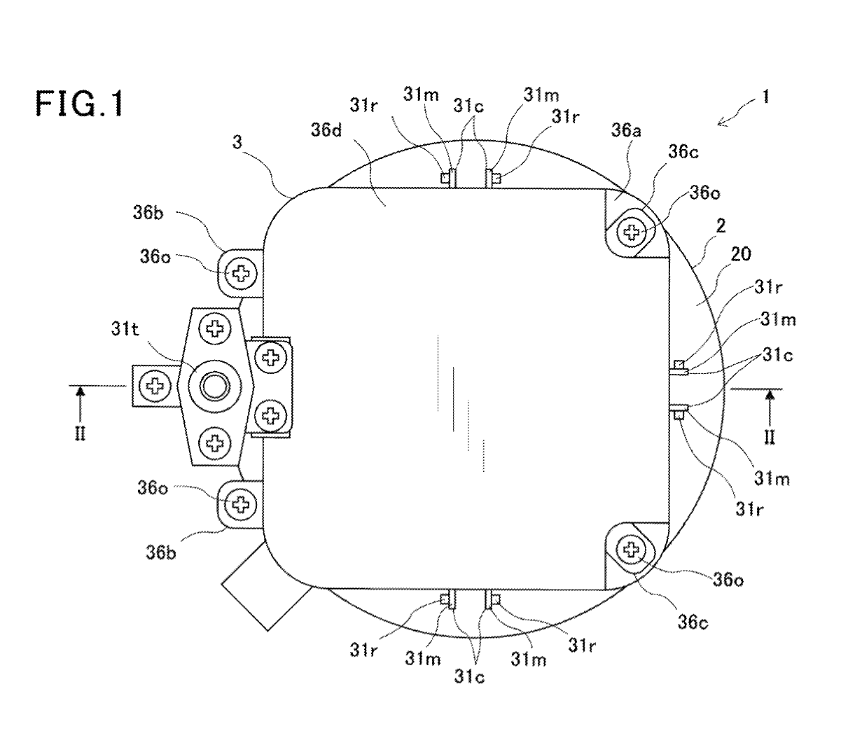

The rotating electric machine integrated with a controller 1 according to the preferred embodiment will be described with reference to FIGS. 1 to 22.

The rotating electric machine integrated with a controller 1 according to the preferred embodiment is an apparatus which generates a driving force to drive a vehicle, by using an electric power which is supplied from a battery B (omitted from a number of drawings) mounted in a vehicle. The apparatus also generates electric power to charge the battery B, by supplying driving force from an engine of the vehicle. The rotating electric machine integrated with a controller 1 (also referred to as an integrated rotating electric machine 1, herein after) is provided with a rotating electric machine and a control apparatus 3.

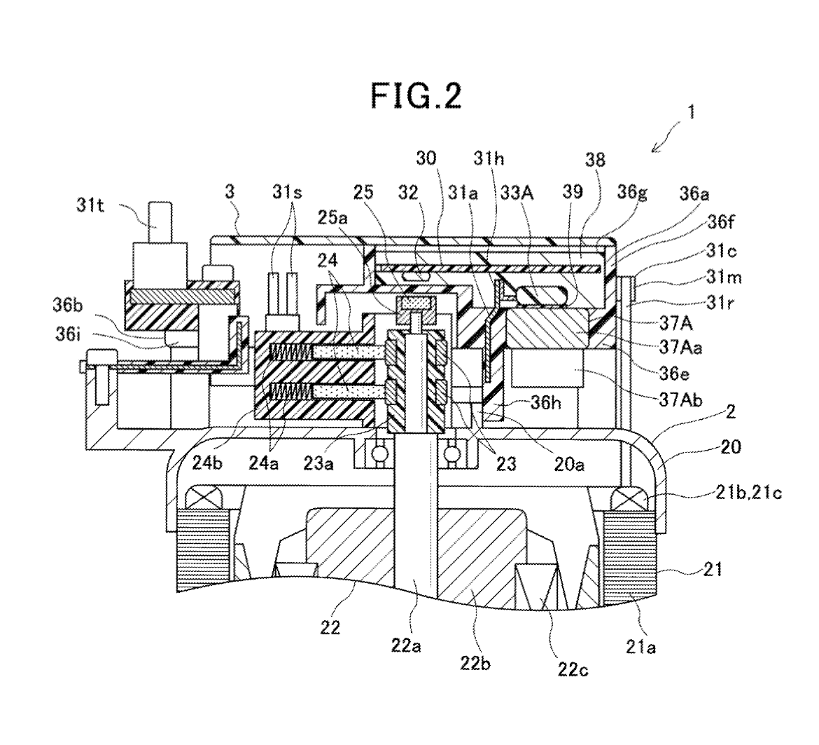

FIG. 1 is a plan view of the rotating electric machine integrated with a controller 1 according to the preferred embodiment viewed from a side opposing a side containing a rotating electric machine. The side in which the rotating electric machine is contained (specifically the side in which the rotating electric machine is mounted) is referred to as ‘2a’ and the opposing side thereof is referred to as ‘2b’ hereinafter. FIG. 2 is a cross sectional view taken across a line II-II in FIG. 1.

### (Rotating Electric Machine)

The rotating electric machine 2 generates the drive force to drive a vehicle by the electric power supply. The rotating electric machine also generates the electric power to charge the battery by a driving force supplied from the engine. The rotating electric machine 2 is provided with a housing 20, a stator 21, a slip ring 23, a brush 24 and a magnet for rotational angle detection 25.

The housing 20 accommodates the stator 21 and a rotor 22, and also supports the rotator 22 in a rotatable state. The control apparatus 3 is fixed. The housing 20 is provided with an arc shaped engaging member 20a which engages the control apparatus 3 when the control apparatus 3 is fixed.

The stator 21 configures a section of a magnetic path and also generates a rotating magnetic field by a flow of a current. The stator 21 is provided with a stator core 21a, and two sets of stator coils 21b and 21c.

The stator 22 configures a part of the magnetic path and also forms a magnetic pole due to a flowing current. The stator 22 is provided with a rotating shaft 22a, a rotor core 22b and rotor coil 22c.

The slip ring 23 and the brush 24 supply a direct current (DC) to the rotor coil 22c. The slip ring 23 is fixed at an outer circumferential surface of the rotating shaft 22a via an insulating member 23a. The brush 24 is retained in a brush holder 24b, and pressed on a side of the rotating shaft 22a via a spring 24a, with an end surface thereof in close contact with an outer periphery surface of the slip ring 23.

The magnet for rotational angle detection 25 generates a magnetic field to detect a rotational angle of the rotor 22. The magnet for rotational angle detection 25 retained in a magnetic holder 25a is fixed to an axial direction end section of the rotating shaft 22a.

### (Control Apparatus)

The control apparatus 3 controls the electric power supplied to the rotating electric machine 2 from the battery B, to generate the driving force of the rotating electric machine 2. The control apparatus 2 also converts the electric power generated by the rotating electric machine 2, and supplies the converted power to the battery B. The controller 3 is the equivalent of a power converter.

As shown in FIG. 1 to FIG. 3 and FIG. 17 respectively, the control apparatus 3 is provided with a wiring board 30, power supply wiring sections 31a, 31b, a stator wiring section 31c (fixed wiring section) a rotor wiring section 31d, a wiring section for external communication 31e, a rotational angle detection circuit IC32, power modules 33 (33A, 33B, 33C), a field system circuit IC34, a microcomputer 35, a case member 36a, fixing members 36b and 36c, a lid member 36d, heat sink 37 (37A, 37B, 37C) for the respective power modules 33 (33A, 33B, 33C), a heat sink for a field system circuit 37D, a heat sink for a micro-computer 37E, and a filling member 38.

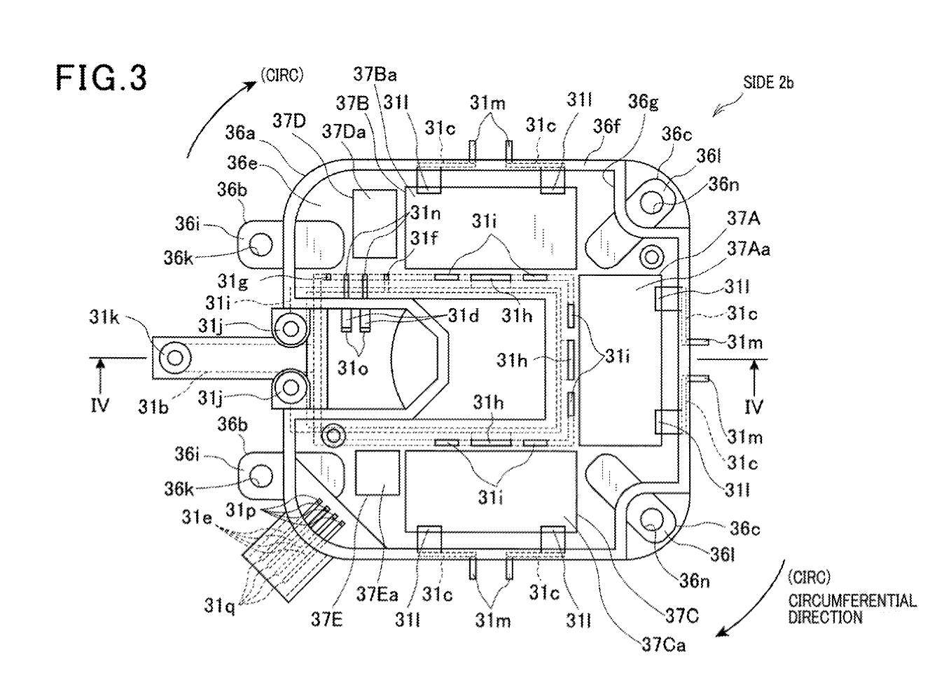

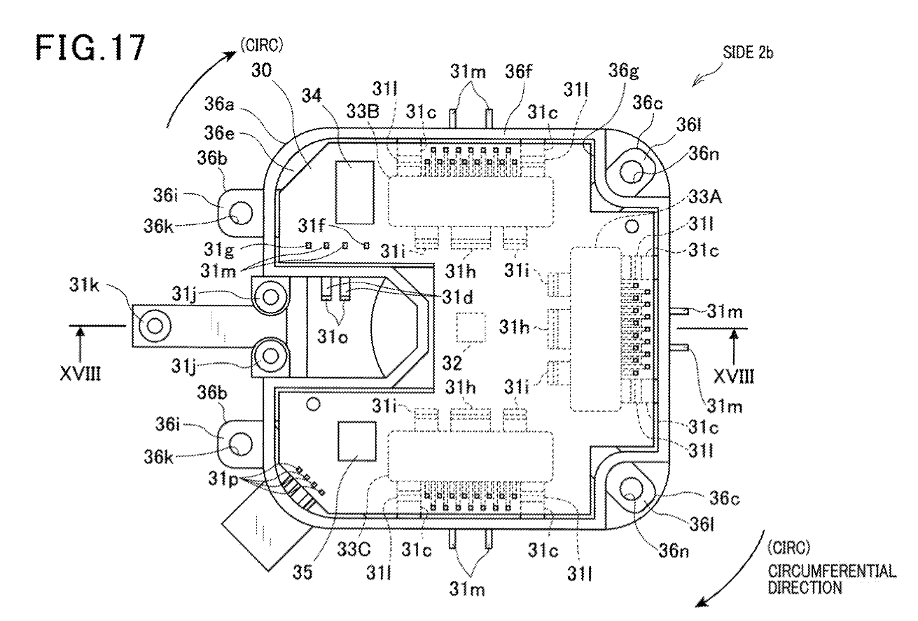

FIG. 3 is a plan view of the case member 36a of the rotating electric machine integrated with a controller 1, viewed from the side 2b of the rotating electric machine according to the preferred embodiment. FIG. 17 is the case member 36a with the wiring board positioned thereon, viewed from the side 2b of rotating electric machine.

The wiring board 30 is an internal wiring section board to connect between the rotational angle detection circuit IC32, the power modules 33A, 33B and 33C, the field system circuit IC34 and the microcomputer 35. The wiring board 30 forms a wiring pattern on a surface and inner layer thereof. The wiring board 30 is equivalent to a control board, and the power modules 33 (33A, 33B, 33C) are equivalent to a module.

The wiring board 30 is formed to extend in a perpendicular direction to a projecting direction of the rotating shaft 22a of the rotating electric machine 2, and in part forms an open circular shape. The so called ‘open circle’ refers to part of a circumference having an open section. More specifically, the open circular shape is missing a circumferential part, and forms, for example, a C shape and a U shape. Additionally, the circular shape missing the circumferential part of the open circular shape may not attain a center (reach a central part). That is, the open circle may be configured to have a missing part from an outer circumferential end towards a central direction.

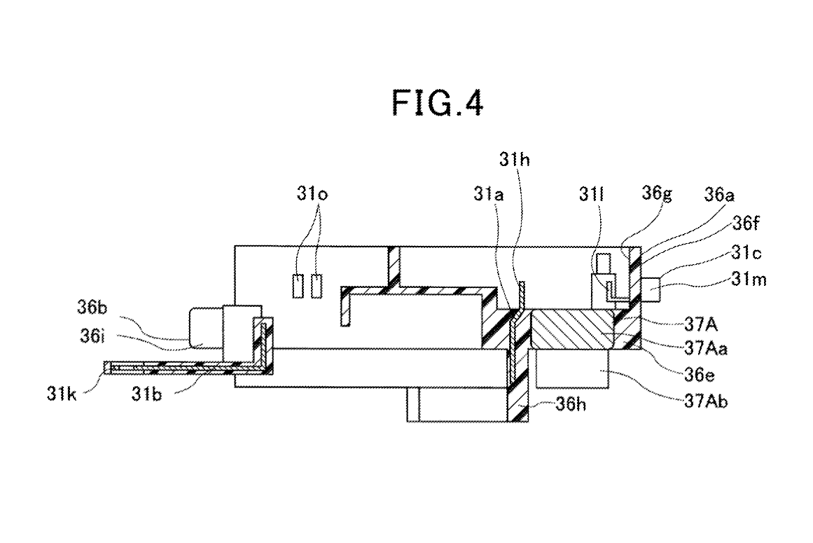

Power supply wiring sections 31a and 31b are external wiring sections for connecting a power supply connector of the wiring board 30 and a power supply terminal of the power modules 33A, 33B and 33C, to the battery B, disposed outside of the case member 36a, as shown in FIG. 3 and FIG. 4. The power supply wiring sections 31a and 31b are made of conductive metal. The power supply wiring sections 31a and 31b may be, for example, a copper sheet or a steel sheet formed in a curved shape. A cross sectional diagram across the line IV-IV in FIG. 3 is shown in FIG. 4.

The power supply wiring sections 31a and 31b are inserted in the case member 36a, having the connectors 31f and 31g of the wiring board 30, and the connectors 31h and 31i of the power modules 33A, 33B and 33C exposed inside of the case member 36a, and also the connectors 31j and 31k of the battery B exposed outside of the case member 36a.

The power supply wiring section 31b is projected from the open section of the open circular shape of the wiring board 30, and a connecting terminal (not shown) which connects an outside battery B to an end section of the power supply wiring section 31b may also be provided at a front end thereof. The connecting terminal is made of a conductive metal to connect with the battery B, for example, from a copper sheet or a steel sheet in a curved shape. The connecting terminal is preferably formed from a curved steel sheet. In providing the connecting terminal formed from a steel sheet, it can still be rigidly fixed to an outside terminal, in order to connect the external battery B, even if the power supply wiring member 31b is formed from a flexible metal such as copper. In this case the connecting terminal is preferably disposed with the power supply wiring member 31b, inserted inside the case member 36a.

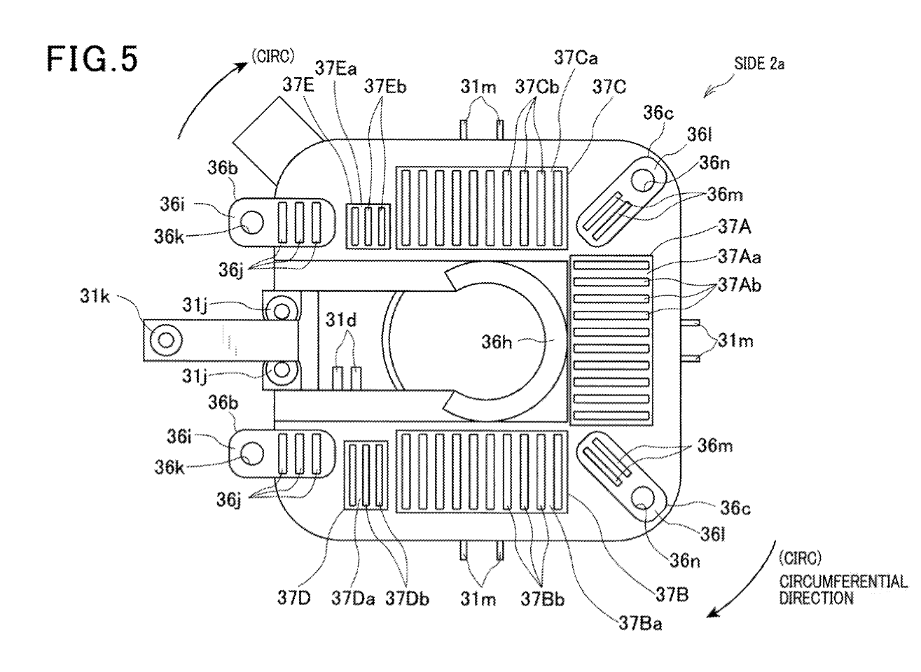

The stator wiring section 31c is an external wiring section, formed from a conductive metal to connect an output terminal of the power modules 33A, 33B to the stator coils 21b and 21c, which are disposed outside of the case member 36a. The stator wiring section 31c, for example, is a copper sheet or a steel sheet in a curved shape. Additionally, the stator wiring section 31c is inserted in the case member 36a, having a connector 31l of the power modules 33A, 33B and 33C, exposed inside the case member 36a, and a connector 31m of the stator coil 21b, exposed outside of the case member 36a. FIG. 5 is a plan view of the case member 36a viewed from a side in which the rotating electric machine is mounted.

The rotor wiring section 31d is an external wiring section and is formed from a conductive metal to connect a rotor coil connector of the wiring board 30 to the rotor coil 22c, which is provided outside the case member 36a, via the brush 24 and the slip ring 23. The rotor wiring section 31d may be formed from, for example, a copper sheet or a steel sheet having a curved shape. The rotor wiring section 31d is inserted in the case member 36a having a connector 31n connected to the wiring board 30 exposed inside of the case member 36a and a connector 31o connected to the brush 24 exposed outside of the case member 36a.

The wiring section for external communication 31e is an external wiring section made of a conductive metal to connect the external communication section of the wiring board 30 to an outside device which is provided outside of the case member 36a. The wiring section for external communication is, for example, a copper plate or a steel plate in a curved shape. Additionally, the wiring section for external communication 31e is inserted in the case member 36a with a connector 31p connected to the wiring board 30 exposed inside the case member 36a, and a connector 31q connected to the outside device exposed outside of the case member 36a.

The rotational angle detection circuit IC32 is an electronic component which is a circuit for the detection of a rotational angle of the rotor 22, from the magnetic field generated by the magnet used for rotational angle detection 25. The rotational angle detection circuit IC32 is provided on the wiring board 30.

The power module 33 is an electronic component which configures an inverter circuit. The power module 33 is provided with a plurality of 4 switching elements (MOSFETs 33a to 33d), a diode 33e and a temperature detection element 33f. The power module 33 is controlled by the microcomputer 35 which converts a direct current (DC) supplied from the battery B, to a three phase alternating current and also supplies the three phase alternating current to the stator coils 21b and 21c, by switching the switching elements (MOSFETs 33a to 33d) at a predefined timing. Also, the three phase alternating current supplied from the stator coils 21b and 21c is converted to a direct current (DC) by the diode 33e and supplied to the battery B, by terminating the switching of the switching element (MOSFETs 33a to 33d).

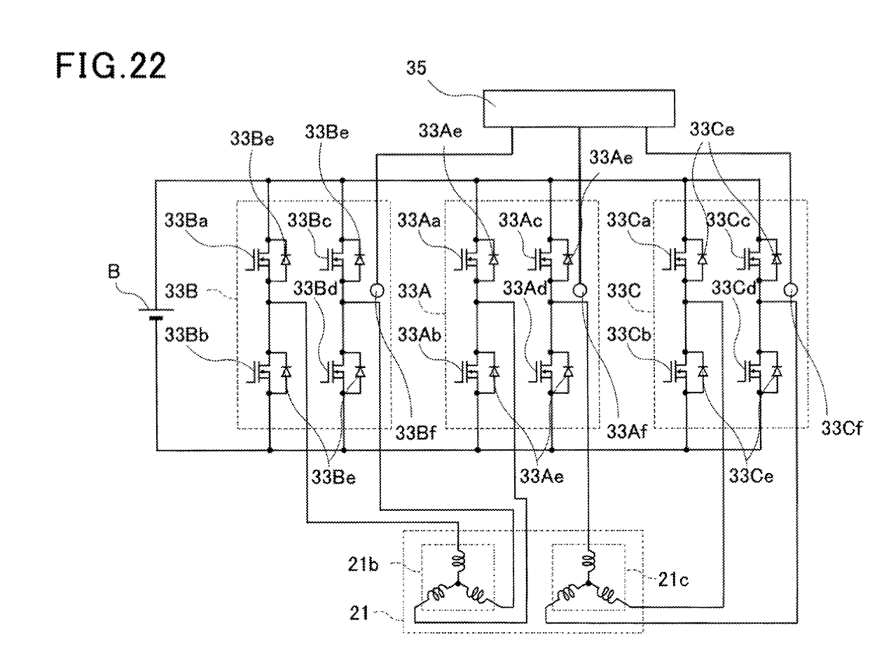

In the preferred embodiment, the three power modules 33A, 33B and 33C are provided as the power module 33. FIG. 22 is a circuit diagram of the rotating electric machine integrated with a controller 1 according to the preferred embodiment.

The power module 33A has 4 switching elements (MOSFET 33Aa to 33Ad). The respective MOSFETs 33Aa and 33Ab are connected in series, and the respective MOSFETs 33Ac and 33Ad are connected in series. Sources of the MOSFETs 33Aa and 33Ac are each connected to a drain of the respective MOSFETs 33Aba and 33Ad. Among the two MOSFETs 33Aa and 33Ab connected in series, the MOSFET 33Aa is a switching element on a high voltage side and the MOSFET 33Ab is a switching element on a low voltage side. The power module 33A is equivalent to at least one module or a first module.

The power module 33B has 4 switching elements (MOSFET 33Ba to 33Bd). The respective MOSFETs 33Ba and 33Bb are connected in series, and the respective MOSFETs 33Bc and 33Bd are connected in series. Sources of the MOSFET 33Ba and 33Bc are each connected to a drain of the respective MOSFETs 33Bb and 33Bd. Among the 2 MOSFETs 33Ba and 33Bb connected in series, the MOSFET 33Ba connected to a positive polar side of the battery B is a switching element for the high voltage side, and MOSFETS 33Bb is switching element for the low voltage side. The power module 33B is equivalent to a second module.

The power module 33C has 4 switching elements (MOSFET 33Ca to MOSFET 33Cd). The respective MOSFETs 33Ca and 33Cb are connected in series and the respective MOSFETs 33Cc and 33Cd are connected in series. Sources (power source) of the MOSFETs 33Ca and 33Cc are each connected to a drain of the respective MOSFETs 33Cb and 33Cd. Among the two MOSFETS 33Ca and 33Cb connected in series, the MOSFET 33Ca connected to a positive electrode of the battery B is a switching element for the high voltage side, and the MOSFET 33Cb is the low voltage switching element. The power module 33C is equivalent to the second module.

As shown in FIG. 22, the power module 33A connects each of the respective MOSFETs 33Aa and 33Ab to one set of three phase stator coils 21b, and the respective MOSFETs 33Ac and 33Ad to another set of three phase stator coils 21c. Specifically, the power module 33A controls two sets of three phase stator coils 21b and 21c.

The power module 33B connects the MOSFETs 33Ba to 33Rd to one set of three phase stator coils 21b. The power module 33C connects the MOSFETs 33Ca to 33Cd to the other set of stator coils 21c. Specifically, each of the power modules 33B and 33C control a different set of three phase stator coils 21b and 21c.

Temperature detection elements 33Af, 336f and 33Cf, mounted in the respective power modules 33A, 33B and 33C, detect a temperature of the module in which the temperature detection element is disposed. In the preferred embodiment, a diode is used for the temperature detection elements 33Af, 33Bf and 33Cf, however a conventional type can also be used. The temperature detection elements 33Af, 33Bf and 33Cf are equivalent to detection elements. A mounting position of the temperature detection elements 33Af, 33Bf and 33Cf in the respective power modules 33A, 33B and 33C is not limited. That is, the temperature detection elements 33Af, 33Bf and 33Cf are preferably mounted in a center (in which a distance therebetween the switching elements is the same) of the 4 switching elements (MOSFET 33a to 33d).

A mode of mounting the temperature detection elements 33Af, 33Bf and 33Cf in the power modules 33A, 33B and 33C is not limited to the described mode. For example, if the power modules 33A, 33B and 33C are molded by resin with other electronic components, such as the switching elements (MOSFETs 33a to 33d), the temperature detection elements may be disposed in close contact with mold resin (the components adhered to the resin), even when the temperature detection elements 33Af, 33Bf and 33Cf are molded unitarily.

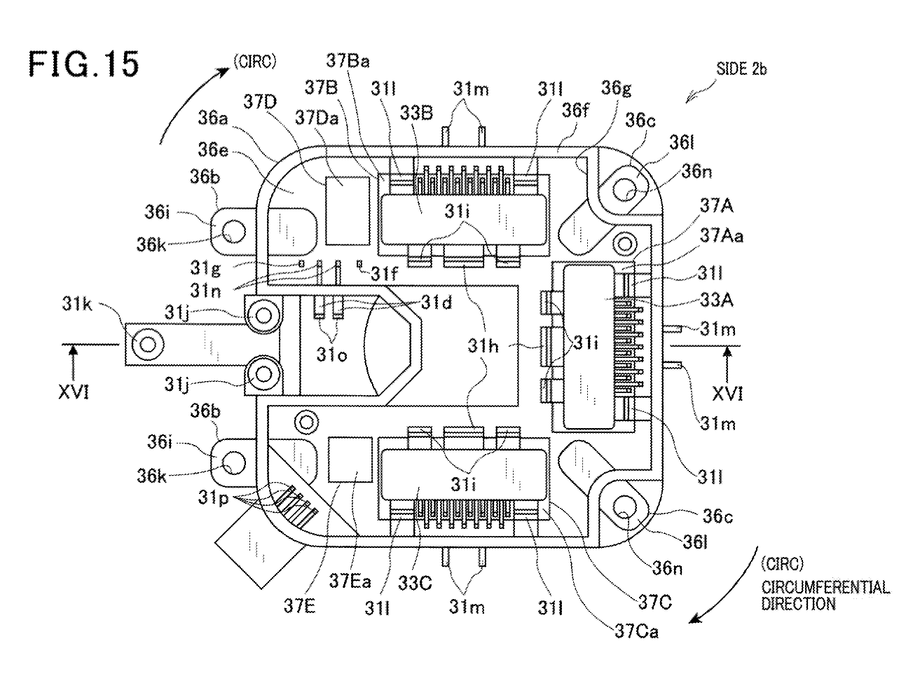

The power modules 33A, 33B and 33C are disposed along the circumferential direction (CIRC) of the open circle of the wiring board 30. The power modules are disposed in a respective order of 33B, 33A, 33C, from one end of the circumferential direction (CIRC) of the open circle of the wiring board towards a second end thereof (as shown in FIG. 15, in the clock wise direction).

That is, the power module 33A is disposed diametrically opposite to the open section of the open circle of the wire board 30. The power modules 33B and 33C are disposed on both sides of the power module 33A, in a circumferential direction (CIRC) thereof. The switching elements (MOSFET 33Aa to 33Ab and 33Ba to 33Rd) controlling the three phase stator coils 21b are arranged on an upper side of the line IV-IV of FIG. 3. The switching elements (MOSFET 33Ac to 33Ad and 33Ca to 33Cd) controlling the set of the three phase stator coil 21c are arranged on a lower side taken across the line IV-IV of FIG. 3.

The field system circuit IC34 is an electronic component which is a circuit for supplying a direct current to the rotor coil 22C, controlled by the microcomputer 35.

The microcomputer 35 is an electronic component which controls the power modules 33A, 33B and 33C, and the field system circuit IC34, based on a command input from outside and a detected result of the rotational angle detection circuit IC32. The microcomputer 35 operates according to a pre-recorded program and controls the power modules 33A, 336 and 33C, and the field system circuit IC34.

A detected signal is inputted from the temperature detection elements 33Af, 33bf and 33Cf disposed in the power modules 33A, 33B and 33C, and the microcomputer 35 detects a state of the power modules 33A, 33B and 33C.

In more detail, if the temperature detection element 33Af (disposed in the power module 33A) detects an abnormal temperature in the power module 33A, then at least one of the two sets of stator coils is determined as being abnormal. Additionally, if the temperature detection elements 33Bf and 33Cf, disposed in the respective power modules 33B and 33C, also detect an abnormal temperature in either one of the power modules 33B and 33C, in addition detected results of the power module 33A, the corresponding sets of stator coils are determined as being abnormal.

It is noted the power modules 33A, 33B and 33C, the field system circuit IC34 and the microcomputer 35 generate heat during operation thereof. Incidentally, the field system circuit IC34 and the microcomputer 35 are low heat generating electronic components, that is, a quantity of heat generated is low. In contrast, the power modules 33A, 33B and 33C are high heat generating electronic components generating a larger quantity of heat than the field system circuit IC34 and the microcomputer 35. The above mentioned heat generating components are equipped with the heat sinks 37A to 37E which are described later on in the specifications.

The case member 36a is formed from resin and accommodates the rotational angle detection circuit IC32, the power modules 33A, 33B and 33C, the field system circuit IC34 and the microcomputer 35 as shown in FIG. 2 to FIG. 5 and FIG. 15 to FIG. 21. The case member 36a is provided with a bottom member 36e, a peripheral wall section 36f, an opening member 36g and an engaging member 36h. The bottom member 36e is a plate shaped section. The peripheral wall section 36f is a cylindrical section formed on a surface side of the bottom member 36e. The engaging member 36h is an arc shaped part formed on a second surface side of the bottom member, which engages with the engaging member 20a of the housing 39 when the rotating electric machine 2 is installed.

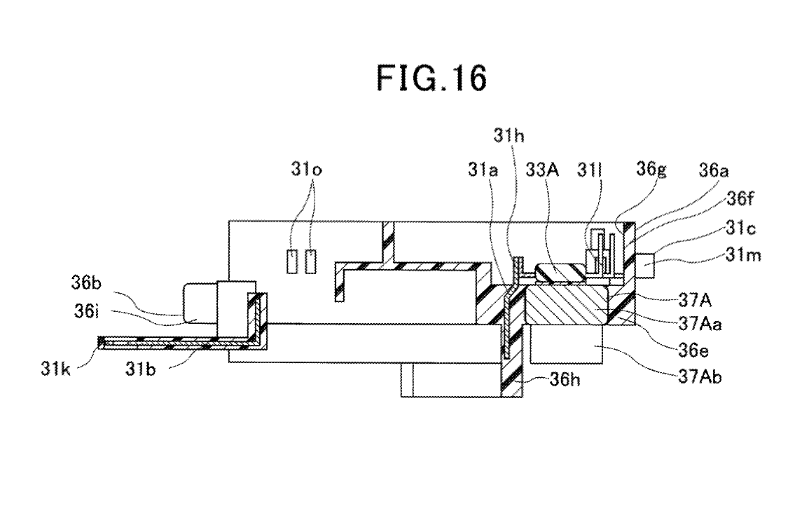

FIG. 15 is a plan view of the case member 36a with the power modules 33A, 33B and 33C arranged in the case member 36a, viewed from the side 2b, which is the side opposing the side 2a, of the rotating electric machine. FIG. 16 is a cross sectional diagram taken across the line XVI-XVI.

The fixing members 36b and 36c are metal formed members which fix the case member 36a to the housing 20. Additionally the fixing members 36b and 36c also dissipate heat generated by the rotating electric machine. The members 36b and 36c are formed from aluminum, for example.

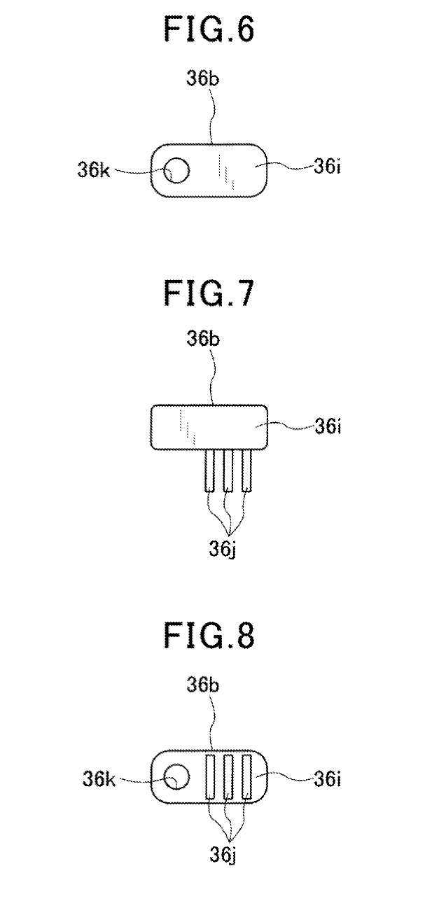

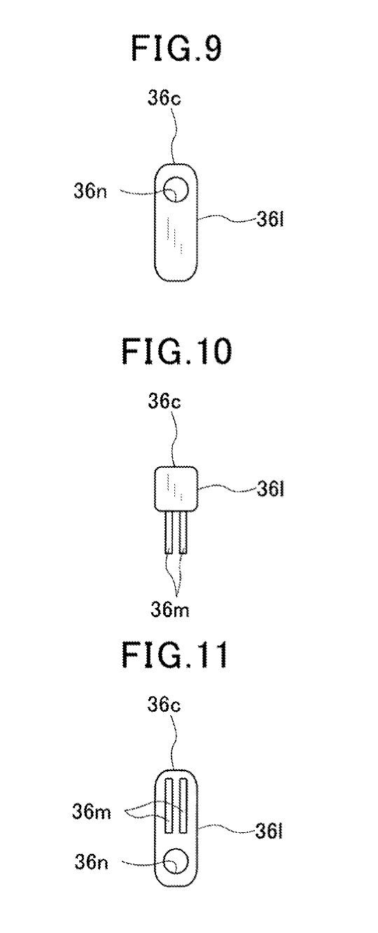

As show in FIG. 6 to FIG. 8, the fixing member 36b is provided with a main body section 36i, a fin member 36j, and a hole section 36k. Additionally, as shown in FIG. 9 to FIG. 11, the fixing member 36c is provided with a main body section 36l, a fin member 36m, and a hole section 36n. The main body sections 36i and 36l are plate formed sections. The fin members 36j and 36m are thin plate sections formed in plurality, which are positioned at fixed intervals on a surface side of the main body sections 36i and 36l. The hole sections 36k and 36n formed on the main body sections 36i and 36l, are holes in which a bolt fixing the case member 36a to the housing 20 is inserted through. As shown in FIG. 5, the fixing members 36b and 36c are inserted in the case member 36a, with the fin members 36j and 36m and the hole sections 36k and 36n exposed outside the case member 36a, on the side 2a in which the rotating electric machine is mounted.

FIG. 6 is a plan view of the fixing member 36b, which is viewed from the side 2b of the rotating electric machine. FIG. 7 is a side view of the fixing member 36b. FIG. 8 is a plan view of the fixing member 36b viewed form a side in which the rotating electric machine is mounted. Additionally, FIG. 9 is a plan view of the fixing member 36c, viewed from the side 2b, opposing the side 2a in which the rotating electric machine is mounted. FIG. 10 is a side view of the fixing member 36c and FIG. 11 is a plan view of the fixing member 36c viewed from the side in which the rotating electric machine is mounted. The lid member 36d is a plate formation made from resin which covers the opening member 36g.

The heat sink 37A for the power module dissipates heat which is generated by the power module 33A, to an outside of the case member 36a. More specifically, the heat sink 37A is made from a metal for dissipating a large amount of heat which is generated by the high heat generating components. For example, the heat sink 37A is formed from aluminum. The heat sinks 37B and 37C are each mounted on the respective power modules 33B and 33C.

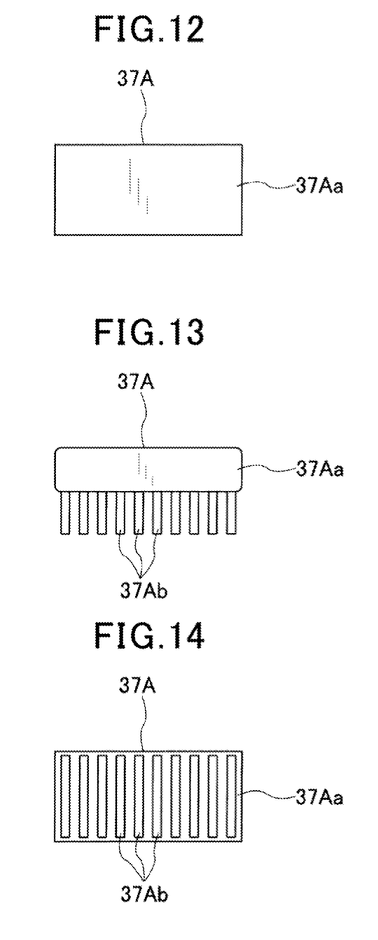

As shown in FIG. 12 to FIG. 14, the heat sink 37A for the power module, is provided with a main body 37Aa, and a fin member 37Ab. The main body 37Aa is a plate shape section. The fin member 37Ab is a thin plate section formed in plurality, which are positioned at fixed intervals on a surface side of the main body sections 36i and 36l. The heat sink 37A for the power module is electrically insulated and inserted in the bottom member 36e with second surface of the main body section 37Aa exposed inside the case member 36a, and also the fin member 37Ab exposed outside the case member 36a of the side (2a) of the rotating electric machine 2. The heat sinks 37B and 37C for the respective power modules 33B and 33C have the same configuration as the heat sink 37A for the power module 33A. That is, the heat sink 37B for the power module 33B is provided with a main body section 37Ba and a fin member 37Bb. The heat sink 37C for a power module 33C is provided with a main body section 37Ca and a fin member 37Cb.

FIG. 12 is a plan view of the heat sink 37A for the power module 33A, viewed from the 2b side of the rotating electric machine. FIG. 13 is a side view of the heat sink 37A for the power module 33A, and FIG. 14 is a plan view of the heat sink 37A for the power module 33A, viewed from the side in which the rotating electric machine is mounted.

The heat sink 37D for the field system circuit IC dissipates heat which is generated by the field system circuit IC34 to the outside of the case member 36a. That is, the heat sink 37D is made from metal and dissipates the low heat generated. The heat sink is made from aluminum, for example. Additionally, the heat sink 37D for the field system circuit IC may be configured (shaped) the same as the heat sink 37A for the power module 33A. More specifically, the heat sink 37D is provided with a main body section 37Da and fin member 37Db.

The heat sink 37E of the microcomputer 35 dissipates heat which is generated by the microcomputer 35 to the outside of the case member 36a. The heat sink 37E is made of metal and dissipates the low heat generated. The heat sink 37E is formed from aluminum, for example. The heat sink 37E for the microcomputer 35 can be configured (shaped) the same as the heat sink 37D for the field system circuit IC, and the heat sink 37A for the power module. That is, the heat sink 37E is provided with a main body section 37Ee and fin member 37Eb.

The fixing members 36b and 36c, heat sinks 37A, 37B and 37C for the respective power modules 33A, 33B and 33C, the heat sink 37D for the field system circuit IC, and the heat sink 37E for the microcomputer 35 are inserted in the case member 36a, intervened between the resin which forms the case member 36a, with an interval separating each component from each other (i.e. in a thermally insulated state). More specifically, heat transfer through each heat sink is regulated.

The heat sinks 37A, 37B and 37C for the power modules, the heat sink 37D for the field system circuit IC, and the heat sink 37E for the microcomputer 35 are arranged in the case member 36a, so that an entire area of the case member 36a, is smaller than an area surrounded by an outline of the case member 36a, when viewed from the side 2a in which the rotating electric machine is mounted, Additionally, the fixing members 36b and 36c are arranged in the case member 36a, so that the entire area of the case member 36a, is smaller than the entire area of the heat sinks 37A, 37B and 37C for the modules, the heat sink 37D for the field system circuit IC and the heat sink 37E for the microcomputer 35, when viewed from the side 2a in which the rotating electric machine is mounted.

The power module 33A is disposed to be in contact with the second side of the main body section 37Aa of the heat sink 37A for the power module, via a thermal conduction member 39 of the thin plate formation having electrical insulating properties. The power source terminal of the power module 33A is connected to each of the connectors 31h and 31i of the power source wiring sections 31a and 31b and the connector 31l of the of the stator wiring section 31c. The power modules 33B and 33C are also connected to an outside terminal, which connects each of the respective heat sinks 37B and 37C, in addition to the power module 33A.

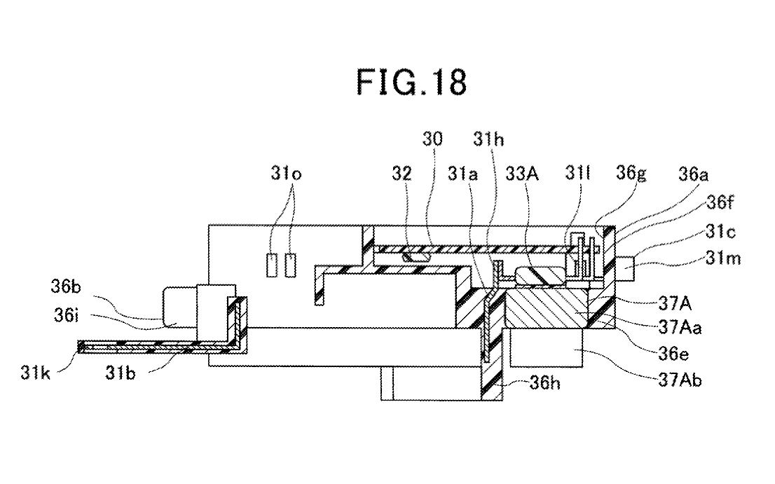

The rotational angle detection circuit IC32 is mounted on a back surface of the wiring board 30, The field system circuit IC34 and the microcomputer 35 are mounted on a surface of the wiring board 30. The wiring board 30 is fixed inside the case member 36a and connected to a signal terminal of the power modules 33A, 33B and 33C, as shown in FIG. 18. Incidentally, FIG. 18 is a cross sectional view across a line XVIII-XVIII shown in FIG. 17.

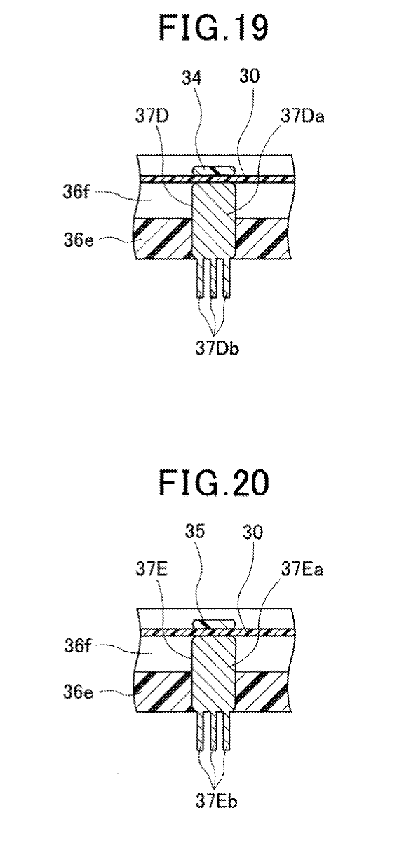

The rotational angle detection circuit IC32 is disposed in a position opposing the magnet for the rotational angle detection 25 and the axial direction. As shown in FIG. 19, the field system circuit IC34 is disposed to be in contact with a second surface of the main body section 37Da of the heat sink 37D for the field system circuit IC34, through the wire board 30. As shown in FIG. 20, the microcomputer 35 is disposed to be in contact with the second surface of the main body section 37Da of the heat sink 37E.

FIG. 19 is a cross sectional diagram showing the field system circuit IC34 and the heat sink 37D for the field system circuit IC. Additionally, FIG. 20 is a cross sectional diagram showing the microcomputer 35 mounted on the wiring board 30 and the heat sink 37E for the microcomputer.

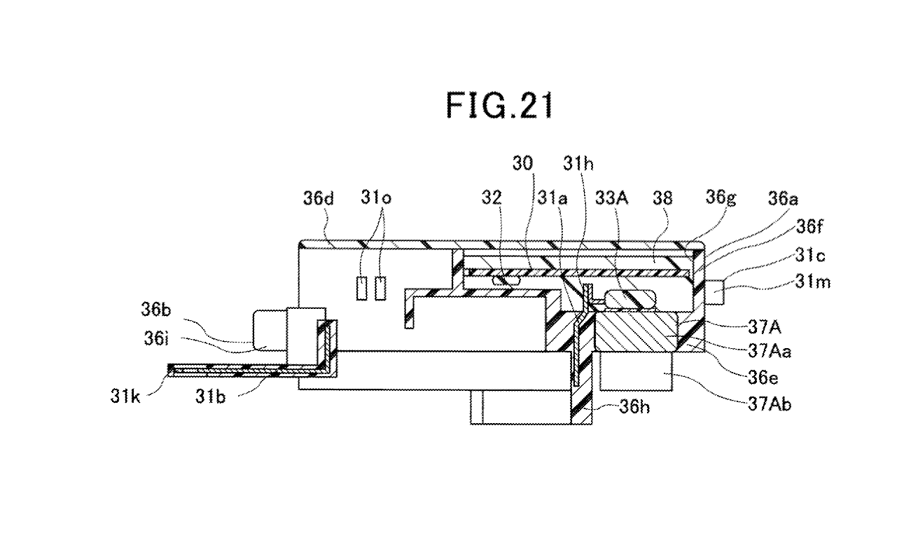

The filler member 38 is a filler or potting resin having electrical insulating properties, filled inside the case member 36a which provides water resistance to the rotational angle circuit IC32, power modules 33A, 33B and 33C, and the field system circuit, for example, which are accommodated inside the case member 36a, as shown in FIG. 21. The FIG. 21 is a cross sectional diagram showing the filler member 38 filled inside the case member 36a.

The filler member 38 is filled inside the case member 36a. The filler member 38 also accommodates the rotational angle detection circuit IC32, the power modules 33A, 33B and 33C, the field system circuit IC34 and the microcomputer 35 inside the case member 36a, which are connected by the wiring board 30, the power source wiring members 31a and 31b, the stator wiring section 31c, the rotor wiring member 31d and the wiring member for external communication 31e. An opening 36g of the case member 36a is covered by the lid member 36d.

The control apparatus 3 fixes the housing 20 by engaging the engaging member 36h of the case member 36a with the engaging member 20a of the rotating electric machine, and by fixing the bolt 36o which is inserted through the hole section 36c. A terminal member 31t, which is provided to connect the positive terminal of the battery B, is connected to the power source wire member 31a. The connector 31k of power source wiring member 31a is connected to a negative terminal of the battery B through a vehicle body. The connector 31m of the stator wiring section 31c is connected to the stator coils 21b and 21c through the wiring member 31r. The connector 31o of the rotor wiring member 31d is connected to the brush 24 through the wiring member 31s.

### (Operation of the Rotating Electric Machine)

Next, the operation of rotating electric machine integrated with a controller will be described.

(Heat Dissipation)

Operation when a driving force is generated which drives the vehicle will be described. The negative terminal of the battery B is connected to the vehicle and connected to the connecter 31k of the power source wiring member 31b through the housing 20. The positive terminal of the battery B is connected to the connector 31j of the power source wiring member 31a through the terminal member 31t, when an ignition switch of the vehicle (not shown) is switched on. As a result, direct current is supplied to the power supply terminal of the power modules 33A to 33C though the connectors 31h and 31i of the power source members 31a and 31b. Direct current is supplied to the wiring board 30 through the connectors 31f and 31g of the respective power source wire members 31a and 31b, and a direct current is also supplied to the rotational angle detection circuit IC32, the field system circuit IC34 and the microcomputer 35 through the wiring pattern of the wiring board 30.

Operation of the rotational angle detection circuit IC32, the field system circuit IC34 and the microcomputer 35 are initiated by supplying the direct current. The rotational angle detection circuit IC32 detects a rotating angle of the rotor 22 from the magnetic field generated by the magnet for rotational angle detection 25a.

The microcomputer 35 controls the power modules 33A, 33B and 33C and the field system circuit IC34 based on a command input from outside through the wire member for external communications 31e, and the wire pattern of the wiring board 30, in addition to a detected result of the rotational angle detection circuit IC32.

The wiring board 30 is connected to the connector 31n of the rotor wiring member 31d. The connector 31o of the rotor wiring member 31d is connected to the brush member 24 through the wiring member 31s. The field system circuit IC34 is controlled by the microcomputer 35, and supplies a direct current to the stator coil 22c through the wire pattern of the wiring board 30, the rotor wiring section 31d, the wiring section 31s, the brush 24 and the slip ring 23.

The wire board 30 is connected to a signal terminal of the power modules 33A, 33B and 33C. Output terminals of the respective power modules 33A, 33B and 33C are connected to the connector 31l of the stator wiring section 31c. The connector 31m of the stator wiring section 31c is connected to the stator coils 21b and 21c through the terminal 31t. The power modules 33A, 33B and 33C controlled by the microcomputer 35, convert the direct current supplied to the power source terminal to a three phase alternating current (AC), and also supply the three phase alternating current to the stator coil 21b through the stator wiring section 31c and the connector 31r. As a result, the rotating electric machine 2 generates the drive force to drive the vehicle.

### (Charging)

Next, operation when generating a electric power for charging the battery B is described.

By supplying the driving force from the engine, the stator coils 21b and 21c generate three phase alternating current. The microcomputer 35 terminates switching of the switching terminals of the respective power modules 33A, 33B and 33C. The diodes of the respective power modules 33A, 33B and 33C convert the three phase alternating current supplied from the stator coils 21b and 21c, to a direct current, through the wiring section 31r and the stator wiring section 31c, and supply the direct current to the battery B through the power source wiring sections 31a and 21b and the terminal member 31t. As a result the battery B is charged by the generated power source of the rotating electric machine 2. Incidentally, the microcomputer 35 may switch the switching elements of the respective power modules 33A, 33B and 33C based the rotational angle detected by the rotational angle detection circuit IC32, and may convert the alternating current which is generated by the stator coils 21b and 21b to a direct current.

(Determination of State)

The rotating electric machine with an integrated controller 1, in the preferred embodiment, may determine a state of the power modules based on a detected signal from the temperature detection elements 33Af, 33BF and 33Cf disposed in the respective power modules 33A, 33B and 33C.

Specifically, electricity flows to the two sets of stator coils 21b and 21c when recharging is performed. When the rotating electric machine 1 is operating normally, the temperature of each of the power modules 33A, 33B and 33C will not exceed a predetermined temperature. When an abnormality occurs in the rotating electric machine 1, the temperature of at least one of the power modules 33A, 33B and 33C increases, and the temperature exceeds a predetermined temperature. In a case of the temperature exceeding the predetermined temperature and increasing further, or in a case of the temperature continuing to exceeded the predetermined temperature over a long period, electric insulating ability of the stator coils 21b and 21c decreases, which in turn leads to a decrease in the generated electric power which charges the battery.

Additionally, if an abnormality occurs in either one of the two sets of stator coils 21b and 21c, abnormal heat generation occurs in a communication pathway of the stator coil in which the abnormality has occurred. For example, if the abnormality occurs in the stator coil 21b, the temperature of the power modules 33A and 33B which controls the stator coil 21b, increases and exceeds the predetermined temperature.

At this point, the temperature detection element 33Af mounted in the power module 33A detects an abnormal temperature thereof. The microcomputer 35 determines an abnormality occurring in at least one of the two sets of stator coils 21b and 21c, by detection of the abnormal temperature of the temperature detection element 33Af, mounted in the power module 33A.

The temperature detection element 33Bf mounted in the power module 33B detects an abnormal temperature of the power module 33B. The microcomputer 35 determines an abnormality which occurs in the corresponding stator coil set (stator coil 21b) by detection results of the abnormal temperature of the power module 33B, together with detection results of the power module 33A.

### Effects of Preferred Embodiment

The effects of the rotating electric machine integrated with a controller 1 according to the preferred embodiment will now be described.

(Effect 1)

The rotating electric machine integrated with a controller 1 according to the preferred embodiment includes the rotating electric machine 2 provided with the stator 21 having two sets of the three phase stator coils 21b and 21c, and the rotor 22, the power converter 3 (control apparatus 3) which configures the control circuit of the rotating electric machine 2, the control board (wiring board 30) equipped with the electronic components, and the plurality of modules (power modules 33A, 33B and 33C) having the plurality of switching elements which are controlled by the control circuit. The rotating electric machine integrated with a controller 1 is configured with at least one of the modules (power module 33A) provided with the switching elements (MOSFET 33Aa to 33Ad) which control the two different sets of stator coils, and the detection element (temperature detection element 33Af) which detects the state of the module (power module 33A).

In the rotating electric machine integrated with a controller 1 according to the preferred embodiment, the at least one of the modules 33A controls two different sets of the stator coils 21b and 21c. Additionally, the state of the at least one of the modules 33A is detected by the temperature detection element. In this instance, by detecting the state of the at least one module 33A by a single temperature detection element, the state of two sets of stator coils (whether or not there is an abnormal temperature) can be detected.

This demonstrates that detection of an abnormality in the entire rotating electric machine integrated with a controller 1 can be detected using a single detection element. In conventional rotating electric machine, a module controls one set of stator coils, thus it is necessary to provide two detection elements to detect an abnormality in an entire machine. According to the rotating electric machine integrated with a controller 1 in the preferred embodiment, the number of detection elements can be decreased. Additionally, it is also shown that a (number of communication ports of the microcomputer 35) and number of connectors of the microcomputer 35 to which the detection elements are connected and the detected results are transmitted to, can also be decreased. This in turn decreases the bulk of the microcomputer 35 and main body structure of the controlling board (wring board 30) in which the microcomputer 35 is mounted. Furthermore, since only a single detection element is provided, a processing time needed to process the detected abnormalities can be shortened.

(Effect 2)

The rotating electric machine integrated with a controller 1 in the preferred embodiment, includes the power converter (control apparatus 3) having the first module (power module 33A) which controls two different sets of stator coils, and the second modules (power module 33B and 33C) which control the same set of stator coils.

According to the rotating electric machine integrated with a controller 1 in the preferred embodiment, when an abnormality occurs in either one of the two sets of stator coils, the stator coil in which the abnormality has occurred can be determined from the detection results for each of the first module (power module 33A) and second module (power modules 33B and 33C), Specifically, in addition to detecting an abnormality in the two sets of stator coils according to the present embodiment, a location in which the abnormality occurs can also be detected.

(Effect 3)

The rotating electric machine integrated with a controller 1 of the preferred embodiment includes the first module (power module 33A) provided with the temperature detection element (33Af) as a detection element, which detects the temperature of thereof.

In the preferred embodiment the state of the first power module (power module 33A) is determined by detection of the temperature thereof. That is, an abnormality thereof can be easily detected.

(Effect 4)

The rotating electric machine integrated with a controller 1 according to the preferred embodiment, includes the second modules (power modules 33B and 33C) provided with the respective temperature detection elements (33bf and 33cf) as detection elements, which detect temperatures of the second modules (33B and 33C).

Additionally, in the preferred embodiment, a state of the second power modules (power modules 33B and 33C) can be determined by the temperature detected in each of the second power modules (33B and 33C). That is, an abnormality thereof can be easily detected. In particular, by combining the third effect with the fourth effect the location in which an abnormality occurs can be easily detected.

(Effect 5)

According to the preferred embodiment, each of the modules (power modules 33A, 33B and 33C) is provided with the respective heat sink (heat sinks for power modules 37A, 37B and 37C) and is disposed in a thermally insulated state from a different module.

As a result, heat transmittance of an adjacent module via the heat sinks (37A, 37B and 37C) to each of the modules (power modules 33A, 33B and 33C) is suppressed, in the preferred embodiment described. As a result, a decrease in the precision of the detected results of transmitted heat is also suppressed.

(Effect 6)

In the preferred embodiment, the control board (wiring board 30) has the open circular shape and each of the modules (power modules 33A, 33B and 33C) is disposed in the circumferential direction (CIRC) thereof. At least one of the modules (power module 33A) is positioned diametrically opposite to the open section of the circle.

The rotating electric machine integrated with a controller 1 in the preferred embodiment includes at least one of the modules (power module 33A) disposed in a position which is not relatively close to the open section of the circular shape. In this case, even if heat dissipation occurs at the open section of the circular shape, heat from at least one of the modules (power module 33A) is suppressed from being dissipated from the open section of the circular shape. As a result, the decrease in detection precision of the detection element is suppressed.

Additionally, modules other than power module 33A (power modules 336 and 33C) will be disposed between the open section of the circular shape. In this case, heat from modules other than power module 33A, that is, heat from the modules power modules 33B and 33C, can be dissipated at the open section of the circular shape. As a result, an effect of heat from the module adjacent to the power module 33A is suppressed.

(Effect 7)

The rotating electric machine integrated with a controller 1 in the preferred embodiment has the control board (wiring board 30) provided with the circular shape, and each module (the power modules 33A, 33B and 33C) disposed along the open circular shape. The first module (power module 33A) is disposed symmetrical to the open section of the circular shape.

According the preferred embodiment, since the first module (power module 33A) is disposed in the diametrically opposite position to the open section of the circular shape in a circumferential direction (CIRC) of the control board (wiring board 30), heat dissipation of the first module (power module 33A) from the open section can be decreased.

That is specifically, a distance between the first module (power module 33A) which detects the state (abnormality) of the stator coils 21b and 21c, and the open section of the circular shape becomes long, and transmission of heat to the open section of the circular shape becomes difficult. As a result, heat transmission to the open section also becomes difficult even if the first module (power module 33A) generates heat. The distance of heat transmission between the first module (power module 33A) and the open section herein, refers to a distance therebetween via the control board.

Furthermore, the second modules (power modules 33B and 33C) are positioned between the first module (power module 33A) and the open section of the in a circumferential direction of the circular shape. As a result, positioning of the second module (power modules 33B and 33C) therebetween prevents heat transmission even when the first module (power module 33A) generates heat, or when heat transmission occurs in circumferential direction toward the open section of the circular shape.

(Effect 8)

In the preferred embodiment, the control board (wiring board 30) has the circular shape, and the connection sections (power source wiring sections 31a and 31b) which connect the switching elements (MOSFETs 33a to 33d) controlling the stator coils 21b and 21c, to the outside connection sections, provided on the open section thereof.

In the preferred embodiment, the connection sections (power source wiring sections 31a and 31b) are also used for heat dissipation at the open section of the circular shape. The connection sections (power source wiring sections 31a and 31b) have good heat dissipating abilities, therefore, when the modules (power modules 33A, 33B and 33C) generate heat, transmittance of the heat occurs through the connection sections (power source wiring sections 31a and 31b) of the modules. That is, a quantity of heat dissipated from the open section m of the circular shape can be increased. As a result, the effect of heat transmission from another module, which is adjacent to the normally functioning module is suppressed, and in turn a decrease of the detection precision of the detection element is also suppressed.

(Effect 9)

The rotating electric machine integrated with a controller 1 in the preferred embodiment, includes the power converter (control apparatus 3) integrated with the connection sections (power source wiring sections 31a and 31b) which connect the outer connection section and the heat sinks (for the power modules 33A, 33B and 33C) in the resin case member 36a, and potted resin (filler member 38) to encapsulate the control board (wiring board 30) and the modules (power modules 33A, 33B and 33C) therein.

In the preferred embodiment, by filling the resin case 36a with the filler (potting resin) the temperature detection elements 33Af, 33Bf and 33Cf of the respective modules (power modules 33A, 33B and 33C) can decrease an effect of a surrounding temperature thereof. Furthermore, if a foreign body exists inside the electric power converter (control apparatus 3), the filler member 38 suppresses contact or collision of the foreign body with other components therein. As a result, a decrease in the detection precision of the detection element is suppressed.

[Modified Mode 1]

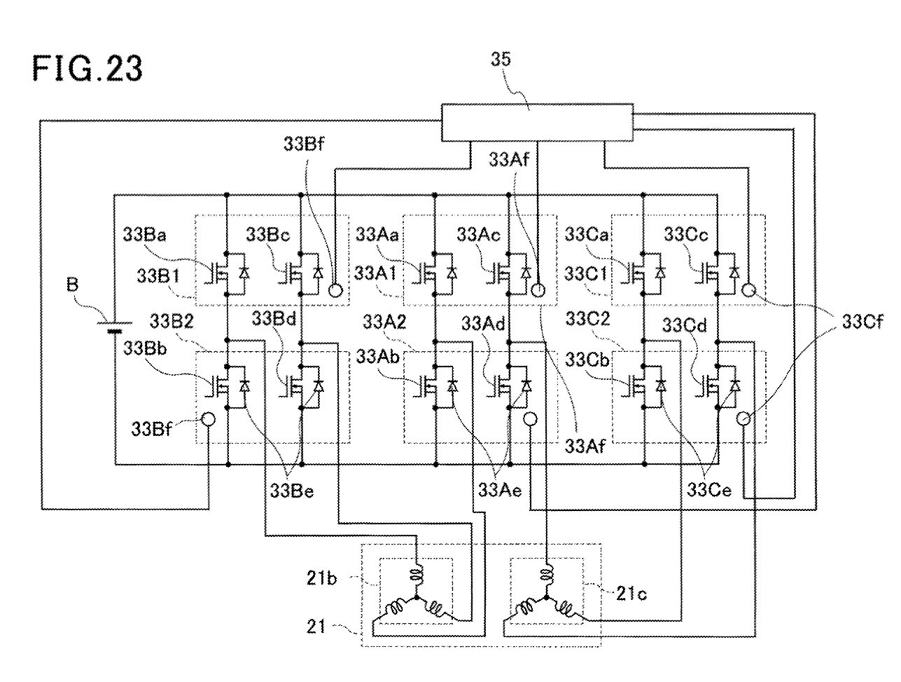

In the preferred embodiment, each of the modules (power modules 33A, 33B and 33C) are provided with 4 switching elements. However, this is not limited to the above described structure. FIG. 23 is a circuit diagram of the rotating electric machine integrated with a controller 1 according to the modified mode 1. As shown in a modified control apparatus in FIG. 23, each of the modules may be provided with two switching elements, for example.

In the modified mode 1, the module corresponding to the power module 33A (or the first module) is configured to control the two different sets of stator coils. The modules corresponding to the other modules 33B and 33C (the second module) may be configured having stator coils provided with either a different phase or the same phase.

Furthermore in the modified mode 1, each of the power modules (power modules 33A, 33B and 33C) having two switching elements is shown, however, a number of switching elements may be changed for each power module. For example, a power module provided with 4 switching elements and a power module provided with 2 switching elements may be used in the same configuration. Additionally, the rotating electric machine integrated with a controller 1 according to the modified mode 1 has the same configuration and elicits the same effect as the rotating electric machine integrated with a controller 1 in the preferred embodiment.

[Modified Mode 2]

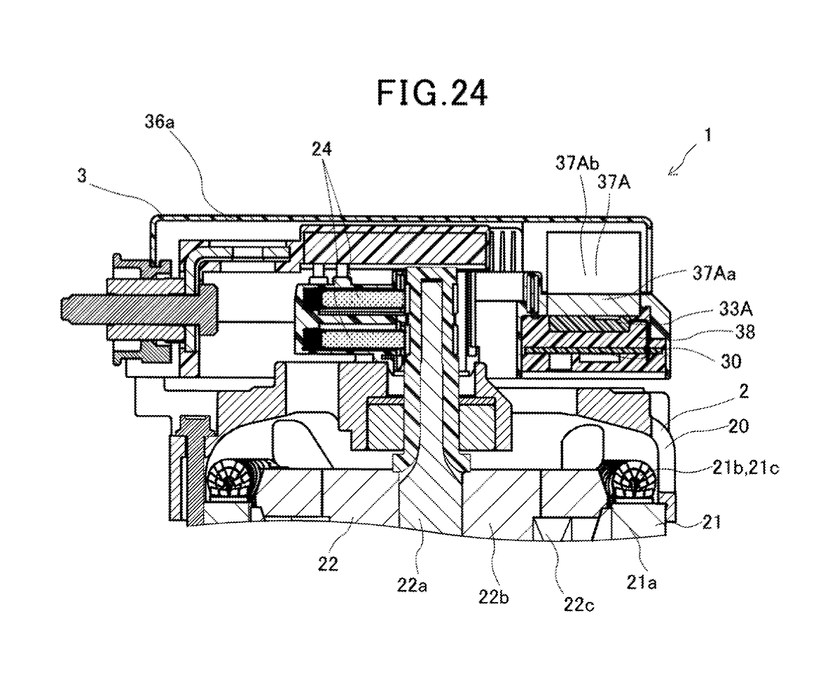

In the preferred embodiment, the control apparatus 3 of the wiring board 30 is mounted so that, the heats sinks 37A, 37B and 37C for the power modules which dissipate heat generated from each of the respective power modules 33A, 33B and 33C, are projected in a direction of the rotating electric machine 2. However, the heat sinks are not limited to mounting positions described. For example, as shown in FIG. 24, the heat sinks maybe mounted with the wiring board 30 in a reversed position. Incidentally, FIG. 24 is a cross section view of the rotating electric machine integrated with a controller 1 provided with the wiring board 30 in a reversed position. FIG. 24 is the same cross section view of the rotating electric machine integrated with a controller 1 shown in FIG. 2. According to the modified mode 2, the rotating electric machine integrated with a controller 1 is provided with the same configuration described in the preferred embodiment and also elicits the same effect of the preferred embodiment. Additionally, the heat sink 37 is projected in a direction towards the case body 36a, and a ventilation passage allowing cooling air to pass through can be provided. As a result, a cooling effect of the heat sink 37 is enhanced.

[Modified Mode 3]

In the preferred embodiment, the temperature detection element is used as the detection element to detect the state of the modules (power modules 33A, 33B and 33C), however determination of a state of the power modules is not limited to the described. That is, for example, a detecting element which detects a flow of a current or a voltage may be incorporated. The rotating electric machine integrated with a controller 1 according to the modified mode 3 is provided with the same configuration and elicits the same effect as described in the preferred embodiment.

[Modified Mode 4]

In the preferred embodiment, the mode in which each heat sink is provided with aluminum having an anodizing layer is described, however, the heat sink is not limited to the configuration described. Each heat sink may be provided with aluminum having an anodizing layer for at least a surface which is in contact with the power modules, 33A, 33B and 33C. Additionally, a layer other than the anodizing layer, for example, a resin layer provided with electric insulating properties may also be used.

The heat sinks may be made of metal other than aluminum having good heat conductivity. For example, copper may also be used. The rotating electric machine integrated with a controller 1 according to the modified mode 4 is provided with the same configuration and elicits the same effects as described in the preferred embodiment.

[Modified Mode 5]

In the preferred embodiment, the rotor 22 of the rotating electric machine 2 is equipped with the rotor coil 22c which forms the magnet pole due to the current flow is described. However, the rotor 22 is not limited to the described. That is, a magnet may be provided as an alternative to the rotor coil 22. In this case, the slip ring 23 and the brush 24 are no longer needed, which also leads the field system circuit IC34 of the controller 3 becoming unnecessary. The rotating electric machine integrated with a controller 1 according to the modified mode 5 is provided with the same configuration and elicits the same effects as described in the preferred embodiment.

### REFERENCE SIGN LIST

1 rotating electric machine integrated with a controller, 2 rotating electric machine, 3 control apparatus, 31 wiring board, 33A, 33B and 33C power module, 33Af, 33Bf and 33Cf, temperature detection element, 35 microcomputer, 38 filler member.

What is claimed is:

1. A rotating electric machine integrated with a controller comprising;
a rotating electric machine provided with a stator and a rotor; and
a power converter provided with a control board and a plurality of power modules; wherein:
the stator has two sets of three phase stator coils;
the control board is equipped with electronical parts configuring a control circuit of the rotating electric machine;
the plurality of power modules are provided with a plurality of switching elements; and
at least one of the power modules is provided with the switching elements which controls two different sets of stator coils; and a detection element which detects a state of the module.

2. The rotating electric machine integrated with a controller, according to claim 1, wherein:
the power converter is provided with the power modules which are divided into a first module and second modules;
the first module controlling the two different sets of the stator coils; and
the second modules controlling a same set of the stator coils.

3. The rotating electric machine integrated with a controller, according to claim 2, wherein:
the first module is provided with a temperature detection element as the detection element, which detects a temperature of the first module.

4. The rotating electric machine integrated with a controller, according to claim 3, wherein:
the second modules are provided with temperature detection elements as detection elements, which detect a temperature of the second modules.

5. The rotating electric machine integrated with a controller, according to claim 1, wherein:
each of the modules are provided with a heat sink and is thermally insulated from other modules among the power modules.

6. The rotating electric machine integrated with a controller, according to claim 1, wherein:
the control board has an open circle provided with two open ends, each of the modules are disposed around a circumferential direction of the open circle, and at least one of the modules is disposed diametrically opposite to a section being an open section of the circle therebetween the two ends.

7. The rotating electric machine integrated with a controller, according to claim 6, wherein:
the control board is provided with the open circle, each of the modules are disposed around the circumferential direction of the open circle, and the first module is disposed diametrically opposite to the open section of the circle.

8. The rotating electric machine integrated with a controller, according to claim 1, wherein:
the open section of the open circle is provided with connectors which connect the switching elements to an external connection section.

9. The rotating electric machine integrated with a controller, according to claim 1, wherein:
the power converter integrated with the connector which connects the external connection section and the heat sinks for the power modules, in the resin case member, is provided with potting resin to encapsulate the control board (wiring board), and the modules (power modules).

10. The rotating electric machine integrated with a controller, according to claim 2, wherein:
each of the modules are provided with a heat sink and is thermally insulated from other modules among the power modules.

11. The rotating electric machine integrated with a controller, according to claim 3, wherein:
each of the modules are provided with a heat sink and is thermally insulated from other modules among the power modules.

12. The rotating electric machine integrated with a controller, according to claim 2, wherein:
the control board has an open circle provided with two open ends, each of the modules are disposed around a circumferential direction of the open circle, and at least one of the modules is disposed diametrically opposite to a section being an open section of the circle therebetween the two ends.

13. The rotating electric machine integrated with a controller, according to claim 3, wherein:
the control board has an open circle provided with two open ends, each of the modules are disposed around a circumferential direction of the open circle, and at least one of the modules is disposed diametrically opposite to a section being an open section of the circle therebetween the two ends.

14. The rotating electric machine integrated with a controller, according to claim 2, wherein:
the open section of the open circle is provided with connectors which connect the switching elements to an external connection section.

15. The rotating electric machine integrated with a controller, according to claim 3, wherein:
the open section of the open circle is provided with connectors which connect the switching elements to an external connection section.

16. The rotating electric machine integrated with a controller, according to claim 4, wherein:
the open section of the open circle is provided with connectors which connect the switching elements to an external connection section.

17. The rotating electric machine integrated with a controller, according to claim 2, wherein:
the power converter integrated with the connector which connects the external connection section and the heat sinks for the power modules, in the resin case member, is provided with potting resin to encapsulate the control board (wiring board), and the modules (power modules).

18. The rotating electric machine integrated with a controller, according to claim 3, wherein:
the power converter integrated with the connector which connects the external connection section and the heat sinks for the power modules, in the resin case member, is provided with potting resin to encapsulate the control board (wiring board), and the modules (power modules).

19. The rotating electric machine integrated with a controller, according to claim 4, wherein:
the power converter integrated with the connector which connects the external connection section and the heat sinks for the power modules, in the resin case member, is provided with potting resin to encapsulate the control board (wiring board), and the modules (power modules).

20. The rotating electric machine integrated with a controller, according to claim 5, wherein:
the power converter integrated with the connector which connects the external connection section and the heat sinks for the power modules, in the resin case member, is provided with potting resin to encapsulate the control board (wiring board), and the modules (power modules).
